(19) United States
(12) Patent Application Publication
(10) Pub. No.: US 2024/0053660 A1
(43) Pub. Date: Feb. 15, 2024

(54) INTERCONNECT MECHANISM FOR IMAGE CAPTURE DEVICE

(71) Applicant: GoPro, Inc., San Mateo, CA (US)

(72) Inventors: Bessy Wen-Han Liang, San Jose, CA (US); Nicholas D. Woodman, Big Sky, MT (US); Nicholas Vitale, Foster City, CA (US); Huy Phuong Nguyen, Alpine, UT (US)

(73) Assignee: GoPro, Inc., San Mateo, CA (US)

(21) Appl. No.: 18/231,412

(22) Filed: Aug. 8, 2023

Related U.S. Application Data
(60) Provisional application No. 63/397,454, filed on Aug. 12, 2022.

(51) Int. Cl. G03B 17/04; G03B 17/12; G03B 17/55; G03B 17/56

(52) U.S. Cl. CPC G03B 17/04; G03B 17/12; G03B 17/55; G03B 17/565

(57) ABSTRACT

A camera housing includes a first surface and a second surface noncoplanar with the first surface. A first interconnect mechanism is coupled to the first surface and rotatable between a collapsed position and an extended position. In the collapsed position, protrusions of the first interconnect mechanism extend parallel to the first surface. In the extended position, the protrusions of the first interconnect mechanism extend in a perpendicular manner away from the first surface. A second interconnect mechanism is coupled to the second surface and rotatable between a collapsed position and an extended position. In the collapsed position, protrusions of the second interconnect mechanism include coplanar surfaces and extend adjacent to the second surface. In the extended position, the protrusions of the second interconnect mechanism extend in a perpendicular manner away from the second surface.

### CROSS-REFERENCE TO RELATED APPLICATION(S)

This application claims priority to and the benefit of U.S. Provisional Application Patent Ser. No. 63/397,454, filed Aug. 12, 2022, the entire disclosure of which is hereby incorporated by reference.

### TECHNICAL FIELD

This disclosure relates to an image capture device that includes multiple interconnect mechanisms to connect to a mounting component.

### BACKGROUND

An image capture device may be mounted to a mounting surface with a mounting component using an interconnect mechanism. Based on the relative locations of the interconnect mechanism, the mounting component, and the mounting surface, the image capture device may impart an undesirable torque to the mounting surface.

### SUMMARY

Disclosed herein are implementations of an image capture device with a body including a front surface positioned opposite a back surface and a top surface positioned opposite a bottom surface. The back surface defines a recess having a recessed surface that is positioned between the front surface and the back surface, and a lens is coupled to the front surface. A first interconnect mechanism is rotatably coupled to the bottom surface, has a collapsed position and an extended position, and extends away from the bottom surface in both the extended position and the collapsed position. A second interconnect mechanism is rotatably coupled to the recessed surface, has a collapsed position and an extended position, and extends away from the back surface in the extended position and is approximately flush with the back surface in the collapsed position.

In certain embodiments, the back surface includes fins configured to dissipate heat.

In certain embodiments, in a first configuration the first interconnect mechanism is configured to connect to a mounting component that is coupled to a mounting surface, and in a second configuration the second interconnect mechanism is configured to connect to the mounting component. A torque imparted to the mounting surface by the image capture device is smaller when in the second configuration than when in the first configuration.

In certain embodiments, in a first configuration the first interconnect mechanism is configured to connect to a mounting component that is coupled to a mounting surface, and in a second configuration the second interconnect mechanism is configured to connect to the mounting component. A distance from the mounting surface to a center of mass the image capture device is smaller when in the second configuration than when in the first configuration.

In certain embodiments, the first interconnect mechanism includes folding protrusions that are configured to rotate toward each other to move from the collapsed position to the extended position.

In certain embodiments, the second interconnect mechanism includes folding protrusions that are configured to rotate toward each other to move from the collapsed position to the extended position.

In a second implementation, a camera housing includes a first surface and a second surface noncoplanar with the first surface. A first interconnect mechanism is coupled to the first surface and rotatable between a collapsed position and an extended position. In the collapsed position, protrusions of the first interconnect mechanism extend parallel to the first surface. In the extended position, the protrusions of the first interconnect mechanism extend in a perpendicular manner away from the first surface. A second interconnect mechanism is coupled to the second surface.

In a third implementation, the image capture device includes a body, an image sensor, and a lens coupled to the body that directs light along an optical axis onto the image sensor. A first interconnect mechanism coupled to the body includes a first protrusion and a second protrusion. The first protrusion is rotatable between a collapsed position and an extended position about a first axis of rotation that is parallel to the optical axis. The second protrusion is rotatable between a collapsed position and an extended position about a second axis of rotation that is parallel to the optical axis. A second interconnect mechanism coupled to the body includes a third protrusion and a fourth protrusion. The third protrusion is rotatable between a collapsed position and an extended position about a third axis of rotation that is perpendicular to the optical axis. The fourth protrusion is rotatable between a collapsed position and an extended position about a fourth axis of rotation that is perpendicular to the optical axis.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIGS. 1A-1B are isometric views of an example of an image capture device.

FIG. 2 is a block diagram of electronic components of an image capture device.

FIG. 3 is an illustration of the image capture device of FIG. 1 coupled to a helmet in a first configuration.

FIG. 4 is an illustration of the image capture device of FIG. 1 coupled to the helmet in a second configuration.

FIG. 5 is an illustration of the image capture device of FIG. 1 coupled to the helmet in a third configuration.

FIG. 6 is an illustration of the image capture device of FIG. 1 coupled to the helmet in a fourth configuration with an accessory mounted to the image capture device.

### DETAILED DESCRIPTION

The present disclosure describes an image capture device that provides a user the ability to mount the image capture device to a structure in various orientations. The image capture device includes a first interconnect mechanism and a second interconnect mechanism that are configured to connect to a mating component that is coupled to a mating surface. The first interconnect mechanism and the second interconnect mechanism are arranged on surfaces of the image capture device that are perpendicular to each other.

In some implementations, the mating surface includes a helmet, and the image capture device is coupled to the helmet to capture images and/or video as a user wearing the helmet performs an activity (e.g., biking, skydiving, skiing, boating, etc.). The mating component may be secured to the helmet in various orientations such that a position and/or orientation of the image capture device is based on the position of the mating component relative to the helmet.

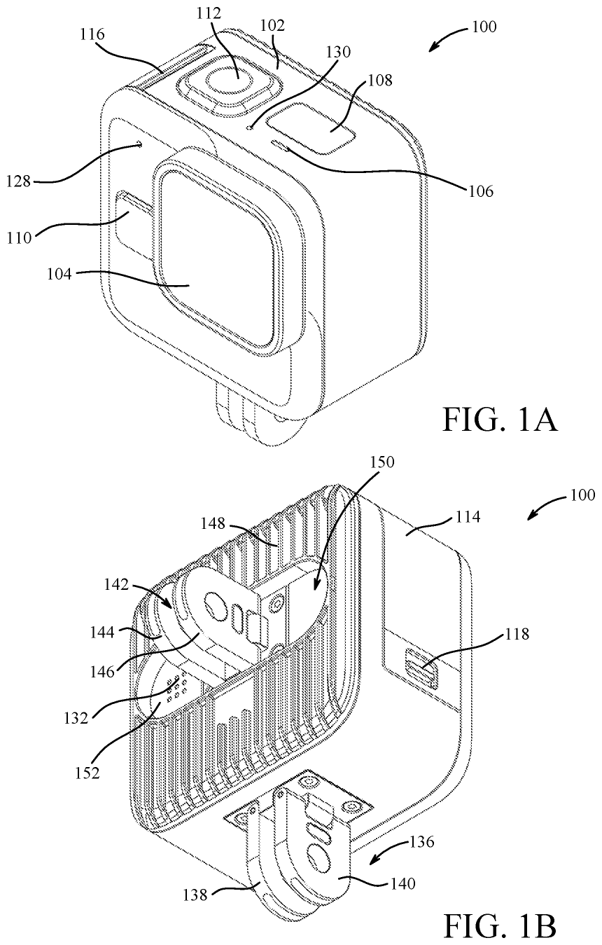

FIGS. 1A-1B are isometric views of an example of an image capture device 100. The image capture device 100 may include a body 102, a lens 104 structured on a front surface of the body 102, various indicators on the front surface of the body 102 (such as light-emitting diodes (LEDs), displays, and the like, not shown), various input mechanisms (such as buttons, switches, and/or touch-screens), and electronics (such as imaging electronics, power electronics, etc.) internal to the body 102 for capturing images via the lens 104 and/or performing other functions. The lens 104 is configured to receive light incident upon the lens 104 and to direct received light onto an image sensor internal to the body 102. The image capture device 100 may be configured to capture images and video and to store captured images and video for subsequent display or playback.

The image capture device 100 may include an LED or another form of an indicator 106 to indicate a status of the image capture device 100 and a liquid-crystal display (LCD) or other form of a display 108 to show status information such as battery life, camera mode, elapsed time, and the like. The image capture device 100 may also include a mode button 110 and a shutter button 112 that are configured to allow a user of the image capture device 100 to interact with the image capture device 100. For example, the mode button 110 and the shutter button 112 may be used to turn the image capture device 100 on and off, scroll through modes and settings, and select modes and change settings. The image capture device 100 may include additional buttons or interfaces (not shown) to support and/or control additional functionality.

The image capture device 100 may include a door 114 coupled to the body 102, for example, using a hinge mechanism 116. The door 114 may be secured to the body 102 using a latch mechanism 118 that releasably engages the body 102 at a position generally opposite the hinge mechanism 116. The door 114 may also include a seal (not shown) and a battery interface (not shown). When the door 114 is an open position, access is provided to an input-output (I/O) interface (not shown) for connecting to or communicating with external devices as described below, to a battery receptacle (not shown) for placement and replacement of a battery (not shown), and to an external memory slot (not shown) configured to receive an external memory device (e.g., a memory card such as an SD card, a microSD card, an SDHC card, an SDXC card, or any other type of external memory device configured to be received by the external memory slot). The battery receptacle includes operative connections (not shown) for power transfer between the battery and the image capture device 100. The external memory slot includes operative connections (not shown) for reading and writing data to an external memory device such that videos can be stored on, and retrieved from, the external memory device. When the door 114 is in a closed position, the seal engages a flange (not shown) or other interface to provide an environmental seal, and the battery interface engages the battery to secure the battery in the battery receptacle. The door 114 can also have a removed position (not shown) where the entire door 114 is separated from the image capture device 100, that is, where both the hinge mechanism 116 and the latch mechanism 118 are decoupled from the body 102 to allow the door 114 to be removed from the image capture device 100.

The image capture device 100 may include a microphone 128 on a front surface and another microphone 130 on a top surface. The image capture device 100 may include other microphones on other surfaces (not shown). The microphones 128, 130 may be configured to receive and record audio signals in conjunction with recording video or separate from recording of video. The image capture device 100 may include a speaker 132 on a recessed surface of the image capture device 100. The image capture device 100 may include other speakers on other surfaces (not shown). The speaker 132 may be configured to play back recorded audio or emit sounds associated with notifications.

A bottom surface of the image capture device 100 may include a first interconnect mechanism 136 for connecting the image capture device 100 to a handle grip or other securing device such as a mating component. In the example shown in FIG. 1B, the first interconnect mechanism 136 includes folding protrusions (e.g., a folding protrusion 138 and a folding protrusion 140) configured to move between a nested or collapsed position (not shown) and an extended or open position as shown that facilitates coupling of the folding protrusions 138, 140 to mating protrusions of other devices such as handle grips, mounts, clips, or like devices. To move between the nested or collapsed position and the extended or open position, the folding protrusions 138, 140 are configured to rotate toward and away from each other, respectively. When in both the collapsed and extended positions, the first interconnect mechanism 136 extends away from the bottom surface of the image capture device 100. In the collapsed position, the folding protrusions 138, 140 may include coplanar surfaces and extend adjacent to the bottom surface of the image capture device 100. In other words, in the collapsed position, the folding protrusions 138, 140 extend away from each other in a common plane located below a plane extending through a bottom surface of the image capture device 100. In the extended position, the folding protrusions 138, 140 may extend perpendicularly away from the bottom surface of the image capture device 100.

A back surface of the image capture device 100 may define a recess 150 that has a recessed surface 152. A second interconnect mechanism 142 for connecting the image capture device 100 to a handle grip or other securing device may be rotatably coupled to the recessed surface 152. In the example shown in FIG. 1B, the second interconnect mechanism 142 includes folding protrusions (e.g., a folding protrusion 144 and a folding protrusion 146) configured to move between a nested or collapsed position (not shown) and an extended or open position as shown that facilitates coupling of the folding protrusions 144, 146 to mating protrusions of other devices such as handle grips, mounts, clips, or like devices. When in the nested or collapsed position, an outer surface of the second interconnect mechanism 142 is approximately flush with the back surface of the image capture device 100. The back surface of the image capture device includes fins 148 that are configured to dissipate heat generated by the internal components of the image capture device 100. In some implementations, an outer surface of the second interconnect mechanism 142 is approximately flush with the fins 148 when the second interconnect mechanism 142 is in the collapsed position. To move between the nested or collapsed position and the extended or open position, the folding protrusions 144, 146 are configured to rotate toward and away from each other, respectively.

In some implementations, the folding protrusions 138, 140 of the first interconnect mechanism 136 and the folding protrusions 144, 146 of the second interconnect mechanism 142 are approximately the same size (e.g., length, width, thickness, etc.). In their extended positions, the folding protrusions 144, 146 of the second interconnect mechanism 142 do not extend as far from the back surface of the image capture device 100 as do the folding protrusions 138, 140 of the first interconnect mechanism 136 from the bottom surface of the image capture device 100. This occurs because the folding protrusions 144, 146 of the second interconnect mechanism 142 are coupled to the recessed surface 152 whereas the folding protrusions 138, 140 of the first interconnect mechanism 136 are coupled to the bottom surface of the image capture device 100.

The image capture device 100 of FIGS. 1A-B includes an exterior that encompasses and protects internal electronics. In the present example, the exterior includes six surfaces (i.e. a front face, a left face, a right face, a back face, a top face, and a bottom face) that form a rectangular or square cuboid. Furthermore, both the front and rear surfaces of the image capture device 100 are rectangular or square. In other embodiments, the exterior may have a different shape. The image capture device 100 may be made of a rigid material such as plastic, aluminum, steel, or fiberglass. The image capture device 100 may include features other than those described here. For example, the image capture device 100 may include additional buttons or different interface features, such as interchangeable lenses, cold shoes, and hot shoes that can add functional features to the image capture device 100.

The image capture device 100 may include various types of image sensors, such as charge-coupled device (CCD) sensors, active pixel sensors (APS), complementary metal—oxide— semiconductor (CMOS) sensors, N-type metal-oxide-semiconductor (NMOS) sensors, and/or any other image sensor or combination of image sensors.

Although not illustrated, in various embodiments, the image capture device 100 may include other additional electrical components (e.g., an image processor, camera system-on-chip (SoC), etc.), which may be included on one or more circuit boards within the body 102 of the image capture device 100.

The image capture device 100 may interface with or communicate with an external device, such as an external user interface device (not shown), via a wired or wireless computing communication link (e.g., an I/O interface). Any number of computing communication links may be used. The computing communication link may be a direct computing communication link or an indirect computing communication link, such as a link including another device or a network, such as the internet, may be used.

In some implementations, the computing communication link may be a Wi-Fi link, an infrared link, a Bluetooth (BT) link, a cellular link, a ZigBee link, a near field communications (NFC) link, such as an ISO/IEC 20643 protocol link, an Advanced Network Technology interoperability (ANT+) link, and/or any other wireless communications link or combination of links.

In some implementations, the computing communication link may be an HDMI link, a USB link, a digital video interface link, a display port interface link, such as a Video Electronics Standards Association (VESA) digital display interface link, an Ethernet link, a Thunderbolt link, and/or other wired computing communication link.

The image capture device 100 may transmit images, such as panoramic images, or portions thereof, to the external user interface device via the computing communication link, and the external user interface device may store, process, display, or a combination thereof the panoramic images.

The external user interface device may be a computing device, such as a smartphone, a tablet computer, a phablet, a smart watch, a portable computer, personal computing device, and/or another device or combination of devices configured to receive user input, communicate information with the image capture device 100 via the computing communication link, or receive user input and communicate information with the image capture device 100 via the computing communication link.

The external user interface device may display, or otherwise present, content, such as images or video, acquired by the image capture device 100. For example, a display of the external user interface device may be a viewport into the three-dimensional space represented by the panoramic images or video captured or created by the image capture device 100.

The external user interface device may communicate information, such as metadata, to the image capture device 100. For example, the external user interface device may send orientation information of the external user interface device with respect to a defined coordinate system to the image capture device 100, such that the image capture device 100 may determine an orientation of the external user interface device relative to the image capture device 100.

Based on the determined orientation, the image capture device 100 may identify a portion of the panoramic images or video captured by the image capture device 100 for the image capture device 100 to send to the external user interface device for presentation as the viewport. In some implementations, based on the determined orientation, the image capture device 100 may determine the location of the external user interface device and/or the dimensions for viewing of a portion of the panoramic images or video.

The external user interface device may implement or execute one or more applications to manage or control the image capture device 100. For example, the external user interface device may include an application for controlling camera configuration, video acquisition, video display, or any other configurable or controllable aspect of the image capture device 100.

The user interface device, such as via an application, may generate and share, such as via a cloud-based or social media service, one or more images, or short video clips, such as in response to user input. In some implementations, the external user interface device, such as via an application, may remotely control the image capture device 100 such as in response to user input.

The external user interface device, such as via an application, may display unprocessed or minimally processed images or video captured by the image capture device 100 contemporaneously with capturing the images or video by the image capture device 100, such as for shot framing or live preview, and which may be performed in response to user input. In some implementations, the external user interface device, such as via an application, may mark one or more key moments contemporaneously with capturing the images or video by the image capture device 100, such as with a tag or highlight in response to a user input or user gesture.

The external user interface device, such as via an application, may display or otherwise present marks or tags associated with images or video, such as in response to user input. For example, marks may be presented in a camera roll application for location review and/or playback of video highlights.

The external user interface device, such as via an application, may wirelessly control camera software, hardware, or both. For example, the external user interface device may include a web-based graphical interface accessible by a user for selecting a live or previously recorded video stream from the image capture device 100 for display on the external user interface device.

The external user interface device may receive information indicating a user setting, such as an image resolution setting (e.g., 3840 pixels by 2160 pixels), a frame rate setting (e.g., 60 frames per second (fps)), a location setting, and/or a context setting, which may indicate an activity, such as mountain biking, in response to user input, and may communicate the settings, or related information, to the image capture device 100.

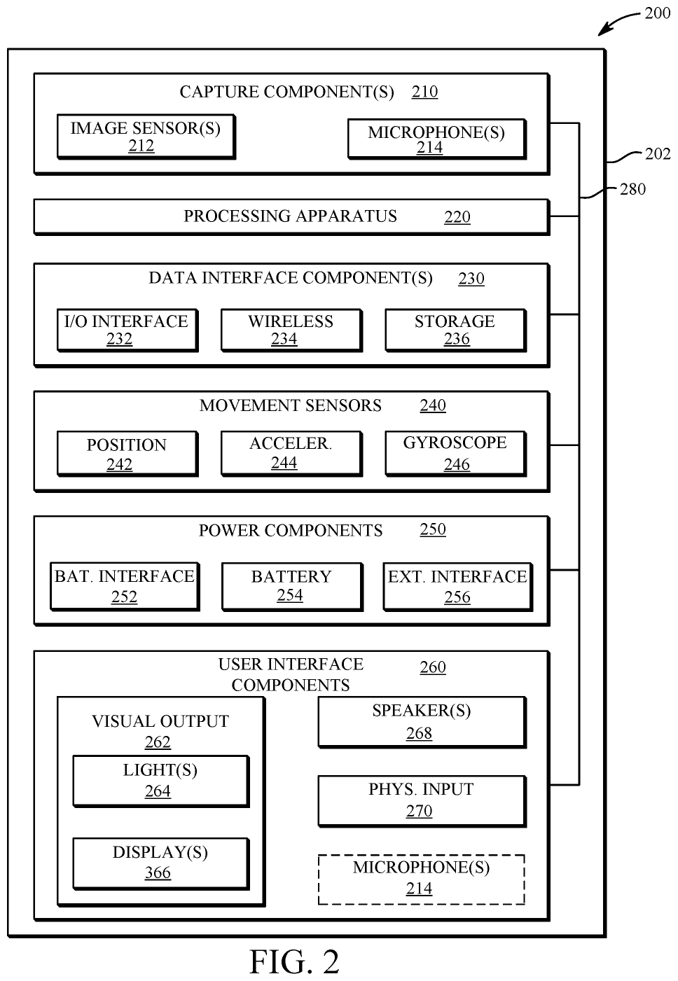

FIG. 2 is a block diagram of electronic components in an image capture device 200. The image capture device 200 may be a single-lens image capture device, a multi-lens image capture device, or variations thereof, including an image capture device with multiple capabilities such as use of interchangeable integrated sensor lens assemblies. The description of the image capture device 200 is also applicable to the image capture device 100 of FIGS. 1A-B.

The image capture device 200 includes a body 202 which includes electronic components such as capture components 210, a processing apparatus 220, data interface components 230, movement sensors 240, power components 250, and/or user interface components 260.

The capture components 210 include one or more image sensors 212 for capturing images and one or more microphones 214 for capturing audio.

The image sensor(s) 212 is configured to detect light of a certain spectrum (e.g., the visible spectrum or the infrared spectrum) and convey information constituting an image as electrical signals (e.g., analog or digital signals). The image sensor(s) 212 detects light incident through a lens coupled or connected to the body 202. The image sensor(s) 212 may be any suitable type of image sensor, such as a charge-coupled device (CCD) sensor, active pixel sensor (APS), complementary metal-oxide-semiconductor (CMOS) sensor, N-type metal—oxide— semiconductor (NMOS) sensor, and/or any other image sensor or combination of image sensors. Image signals from the image sensor(s) 212 may be passed to other electronic components of the image capture device 200 via a bus 280, such as to the processing apparatus 220. In some implementations, the image sensor(s) 212 includes a digital-to-analog converter. A multi-lens variation of the image capture device 200 can include multiple image sensors 212.

The microphone(s) 214 is configured to detect sound, which may be recorded in conjunction with capturing images to form a video. The microphone(s) 214 may also detect sound in order to receive audible commands to control the image capture device 200.

The processing apparatus 220 may be configured to perform image signal processing (e.g., filtering, tone mapping, stitching, and/or encoding) to generate output images based on image data from the image sensor(s) 212. The processing apparatus 220 may include one or more processors having single or multiple processing cores. In some implementations, the processing apparatus 220 may include an application specific integrated circuit (ASIC). For example, the processing apparatus 220 may include a custom image signal processor. The processing apparatus 220 may exchange data (e.g., image data) with other components of the image capture device 200, such as the image sensor(s) 212, via the bus 280.

The processing apparatus 220 may include memory, such as a random-access memory (RAM) device, flash memory, or another suitable type of storage device, such as a non-transitory computer-readable memory. The memory of the processing apparatus 220 may include executable instructions and data that can be accessed by one or more processors of the processing apparatus 220. For example, the processing apparatus 220 may include one or more dynamic random-access memory (DRAM) modules, such as double data rate synchronous dynamic random-access memory (DDR SDRAM). In some implementations, the processing apparatus 220 may include a digital signal processor (DSP). More than one processing apparatus may also be present or associated with the image capture device 200.

The data interface components 230 enable communication between the image capture device 300 and other electronic devices, such as a remote control, a smartphone, a tablet computer, a laptop computer, a desktop computer, or a storage device. For example, the data interface components 230 may be used to receive commands to operate the image capture device 200, transfer image data to other electronic devices, and/or transfer other signals or information to and from the image capture device 200. The data interface components 230 may be configured for wired and/or wireless communication. For example, the data interface components 230 may include an I/O interface 232 that provides wired communication for the image capture device 200, which may be a USB interface (e.g., USB type-C), a high-definition multimedia interface (HDMI), or a FireWire interface. The data interface components 230 may include a wireless data interface 234 that provides wireless communication for the image capture device 200, such as a Bluetooth interface, a ZigBee interface, and/or a Wi-Fi interface. The data interface components 230 may include a storage interface 236, such as a memory card slot configured to receive and operatively couple to a storage device (e.g., a memory card) for data transfer with the image capture device 200 (e.g., for storing captured images and/or recorded audio and video).

The movement sensors 240 may detect the position and movement of the image capture device 200. The movement sensors 240 may include a position sensor 242, an accelerometer 244, or a gyroscope 246. The position sensor 242, such as a global positioning system (GPS) sensor, is used to determine a position of the image capture device 200. The accelerometer 244, such as a three-axis accelerometer, measures linear motion (e.g., linear acceleration) of the image capture device 200. The gyroscope 246, such as a three-axis gyroscope, measures rotational motion (e.g., rate of rotation) of the image capture device 200. Other types of movement sensors 240 may also be present or associated with the image capture device 200.

The power components 250 may receive, store, and/or provide power for operating the image capture device 200. The power components 250 may include a battery interface 252 and a battery 254. The battery interface 252 operatively couples to the battery 254, for example, with conductive contacts to transfer power from the battery 254 to the other electronic components of the image capture device 200. The power components 250 may also include an external interface 256, and the power components 250 may, via the external interface 256, receive power from an external source, such as a wall plug or external battery, for operating the image capture device 200 and/or charging the battery 254 of the image capture device 200. In some implementations, the external interface 256 may be the I/O interface 232. In such an implementation, the I/O interface 232 may enable the power components 250 to receive power from an external source over a wired data interface component (e.g., a USB type-C cable).

The user interface components 260 may allow the user to interact with the image capture device 200, for example, providing outputs to the user and receiving inputs from the user. The user interface components 260 may include visual output components 262 to visually communicate information and/or present captured images to the user. The visual output components 262 may include one or more lights 264 and/or more displays 266. The display(s) 266 may be configured as a touch screen that receives inputs from the user. The user interface components 260 may also include one or more speakers 268. The speaker(s) 268 can function as an audio output component that audibly communicates information and/or presents recorded audio to the user. The user interface components 260 may also include one or more physical input interfaces 270 that are physically manipulated by the user to provide input to the image capture device 200. The physical input interfaces 270 may, for example, be configured as buttons, toggles, or switches. The user interface components 260 may also be considered to include the microphone(s) 214, as indicated in dotted line, and the microphone(s) 214 may function to receive audio inputs from the user, such as voice commands.

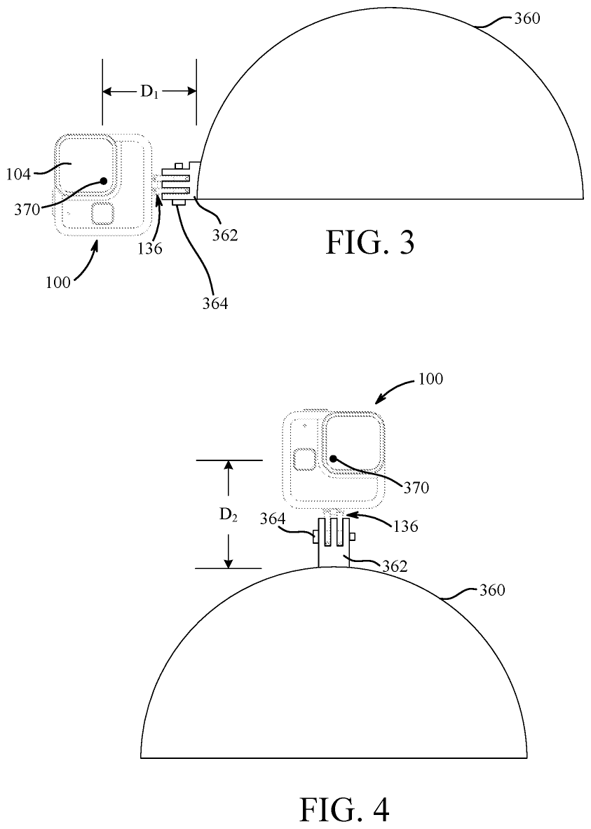

FIG. 3 is an illustration of the image capture device 100 of FIG. 1 coupled to a helmet 360 in a first configuration. A user may desire to wear the helmet 360 when performing an activity, such as biking, skydiving, boating, skiing, etc., and may desire to record a video of the activity to share with others (e.g., via social media, private messages, etc.). Prior to donning the helmet 360, the user may secure a mounting component 362 to a mounting surface (e.g., an external surface) of the helmet 360 in a desired orientation. As shown in FIG. 3, the user may secure the mounting component 362 to the helmet 360 on a side of the helmet 360 such that the mounting component 362 extends from the helmet 360 in a direction approximately perpendicular to the face of the user. To couple the image capture device 100 to the helmet 360, the first interconnect mechanism 136 interfaces with the mounting component 362 and is secured to the mounting component 362 with a connector 364 (e.g., a threaded connector such as a thumbscrew, set screw, etc.). Assembled as shown, when the user wears the helmet 360, the device 100 is positioned to a side of the head of the user (e.g., near an ear of the user). In this configuration, the lens 104 will capture a viewpoint that would be adjacent to a given side (vs. aligned with) a viewpoint of the user wearing the helmet 360.

As shown in FIG. 3, D₁ indicates a first distance (e.g., a perpendicular distance) between the outer surface of the helmet 360 and a center of mass 370 of the image capture device 100. Oriented as shown in FIG. 3, the image capture device 100 imparts a torque T₁ to the mounting surface of the helmet 360 that is equal to the weight of the image capture device 100 (e.g., the mass of the image capture device 100 multiplied by the gravitational acceleration) multiplied by D₁. To counteract the torque T₁ and prevent the helmet 360 from rotating in the direction of the torque T₁, the user's neck must exert a torque that is equal and opposite to that imparted to the outer surface of the helmet 360 by the image capture device 100. Over time, the user may tire from exerting this counteracting torque.

In addition, the user may desire to record the activity to provide a “first person view” of the activity. For example, when another person views the video, the user desires for the other person to view the activity through the eyes of the user (e.g., to feel as though the other person is actually performing the activity). However, mounting the image capture device 100 as described in FIG. 3 causes the lens 104 to be positioned away from the eyes of the user, and the other person may not feel as though they are actually performing the activity when they view the recorded video.

FIG. 4 is an illustration of the image capture device 100 of FIG. 1 coupled to the helmet 360 in a second configuration. The user may secure the mounting component 362 to the helmet 360 on a top of the helmet 360 such that the mounting component 362 extends from the helmet 360 in a direction approximately parallel to the face of the user. To couple the image capture device 100 to the helmet 360, the first interconnect mechanism 136 interfaces with the mounting component 362 and is secured to the mounting component 362 with the connector 364. Assembled as shown, when the user wears the helmet 360, the image capture device 100 is positioned above the head of the user (e.g., above a top of the head of the user and approximately centered over the head of the user).

As shown in FIG. 4, D₂ indicates a second distance (e.g., a perpendicular distance) between the outer surface of the helmet 360 and the center of mass 370 of the image capture device 100. When the user's face is straight (e.g., facing straight ahead, etc.) the image capture device 100 does not impart a torque to the mounting surface of the helmet 360. In some implementations, when the user looks up, looks down, tilts the user's head to the right, to the left, etc., the image capture device 100 imparts a torque T₂ to the mounting surface of the helmet 360 that is equal to the weight of the image capture device 100 (e.g., the mass of the image capture device 100 multiplied by the gravitational acceleration) multiplied by D₂. To counteract the torque T₂ and prevent the helmet 360 from over-rotating in the direction of the torque T₂, the user's neck must exert a torque that is equal and opposite to that imparted to the outer surface of the helmet 360 by the image capture device 100. Over time, the user may tire from exerting this counteracting torque.

In this configuration, the lens 104 will capture a viewpoint that would be vertically offset from (vs. aligned with) a viewpoint of the user wearing the helmet 360 (e.g., the image capture device 100 is positioned above the head of the user). Accordingly, the image capture device 100 may also provide a perspective that does not make the other person feel as though they are actually performing the activity when they view the recorded video.

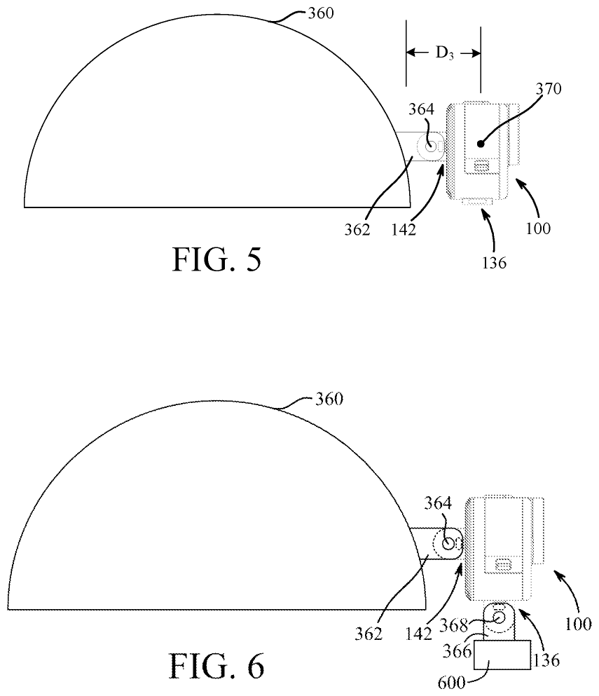

FIG. 5 is an illustration of the image capture device 100 of FIG. 1 coupled to the helmet 360 in a third configuration. The user may secure the mounting component 362 to the helmet 360 on the front of the helmet 360 such that the mounting component 362 extends from the helmet 360 in a direction approximately parallel to the nose of the user. To couple the image capture device 100 to the helmet 360, the second interconnect mechanism 142 interfaces with the mounting component 362 and is secured to the mounting component 362 with the connector 364. Assembled as shown, when the user wears the helmet 360 the image capture device 100 is positioned in front of the head of the user (e.g., approximately in front of the eyes of the user). Positioned as described, the image capture device 100 may provide a view that more closely resembles the view of the user when another person views the captured video.

As shown in FIG. 5, D₃ indicates a third distance (e.g., a perpendicular distance) between the outer surface of the helmet 360 and the center of mass 370 of the image capture device 100. Oriented as shown in FIG. 5, the image capture device 100 imparts a torque T₃ to the mounting surface of the helmet 360 that is equal to the weight of the image capture device 100 (e.g., the mass of the image capture device 100 multiplied by the gravitational acceleration) multiplied by D₃. To counteract the torque T₃ and prevent the helmet 360 from rotating in the direction of the torque T₃, the user's neck must exert a torque that is equal and opposite to that imparted to the outer surface of the helmet 360 by the image capture device 100.

When in the extended position, the folding protrusions 144, 146 extend from the back surface of the image capture device 100 a shorter distance than the folding protrusions 138, 140 extend from the bottom surface of the image capture device 100. Accordingly, when mounting the image capture device 100 to the helmet 360 (or another mounting surface and/or component) using the second interconnect mechanism 142, the image capture device 100 is closer to the helmet 360 than when using the first interconnect mechanism 136. For example, the distance D₃ is smaller than both distances D₂ and D₁ because the distance D₃ is a result of using the second interconnect mechanism 142 instead of using the first interconnect mechanism 136. Therefore, the torque T₃ is also smaller than both torques T₂ and T₁. Using the second interconnect mechanism 142 may be more comfortable for the user because less effort from the user is required to counteract the torque T₃ than to counteract the torques T₂ and T₁.

Furthermore, using the second interconnect mechanism 142 allows the user to mount the image capture device 100 closer to the helmet 360 than when using the first interconnect mechanism 136. The position and orientation of the second interconnect mechanism 142 also allows the image capture device 100 to be mounted closer to the eyes of the user than when using the first interconnect mechanism 136. Accordingly, the view from the lens 104 when using the second interconnect mechanism 142 may be closer to a “first person view” than the views provided when using the first interconnect mechanism 136 and may provide another user a more immersive experience when viewing the recorded video.

FIG. 6 is an illustration of the image capture device of FIG. 1 coupled to the helmet 360 in a fourth configuration with an accessory 600 mounted to the image capture device 100. Though a helmet 360 is shown, the mating surface may be another item, like a chest harness, a necklace, a wrist mount, a headband, etc.

In some implementations, both the first interconnect mechanism 136 and the second interconnect mechanism 142 are connected to a mating component that is coupled to a mating surface. For example, the first interconnect mechanism 136 may be coupled to the helmet 360 via the mounting component 362 and the connector 364 while the second interconnect mechanism 142 may be coupled to the accessory 600 via a mounting component 366 and a connector 368. In another example, such as shown in FIG. 6, the second interconnect mechanism 142 may be coupled to the helmet 360 via the mounting component 362 and the connector 364 while the first interconnect mechanism 136 may be coupled to the accessory 600 via the mounting component 366 and the connector 368.

The accessory 600 may be an external microphone, a light, a speaker, an external battery, an external display, an external memory, a wireless communication device, a second camera, or the like. The accessory 600 may include or be coupled to the mounting component 366 and the connector 368 may be used with the mounting component 366 to secure the accessory 600 to the image capture device 100. For example, the connector 368 may be a screw, a magnet, a rod, etc.

In some implementations, the first interconnect mechanism 136 and/or the second interconnect mechanism 142 may include an electrical terminal configured to connect with an electrical terminal on a mating component of another device such as the accessory 600, a handle grip, a mount, a clips, or another device. The electrical terminal(s) on the first interconnect mechanism 136 and/or the second interconnect mechanism 142 may be electrically connected to components of the image capture device 100, such as the data interface components 230 (i.e., the I/O interface 232, the wireless data interface 234, and/or the storage interface 236) and the power components 250 (i.e., the battery interface 252, the battery 254, and/or the external interface 256).

When the electrical terminal on the mating component of the other device is connected to the electrical terminal on the first interconnect mechanism 136 or the second interconnect mechanism 142, the other device may be connected to components of the image capture device 100. For example, when the accessory 600 includes a light connected to the first interconnect mechanism 136, the light may draw power from the battery 254 of the image capture device 100. In another example, when the accessory 600 includes an external memory connected to the image capture device 100 via the second interconnect mechanism 142, the external memory may receive data from the data interface components 230 of the image capture device 100.

In some implementations, both the first interconnect mechanism 136 and the second interconnect mechanism 142 may be mounted to a mating component on the same mounting surface. For example, both the first interconnect mechanism and the second interconnect mechanism may be connected to the helmet 360 at different locations or at the same location at different times. Mounting the image capture device 100 using the multiple interconnect mechanisms 136, 142 may increase the stability and versatility of the image capture device 100 and may improve captured images.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. An image capture device, comprising:
a body including a front surface positioned opposite a back surface and a top surface positioned opposite a bottom surface, wherein the back surface defines a recess having a recessed surface that is positioned between the front surface and the back surface;
a lens coupled to the front surface;
a first interconnect mechanism rotatably coupled to the bottom surface and having a collapsed position and an extended position, wherein the first interconnect mechanism extends away from the bottom surface in both the extended position and the collapsed position; and
a second interconnect mechanism rotatably coupled to the recessed surface and having a collapsed position and an extended position, wherein the second interconnect mechanism extends away from the back surface in the extended position and is approximately flush with the back surface in the collapsed position.

2. The image capture device of claim 1, wherein the back surface includes fins configured to dissipate heat.

3. The image capture device of claim 1, wherein in a first configuration of the image capture device, the first interconnect mechanism is configured to connect to a mounting component, wherein in a second configuration of the image capture device, the second interconnect mechanism is configured to connect to the mounting component, and wherein a torque imparted to the mounting component by the image capture device is less when the image capture device is in the second configuration than when the image capture device is in the first configuration.

4. The image capture device of claim 1, wherein in a first configuration of the image capture device, the first interconnect mechanism is configured to connect to a mounting component, wherein in a second configuration of the image capture device, the second interconnect mechanism is configured to connect to the mounting component, and wherein a distance from the mounting component to a center of mass the image capture device is less when the image capture device is in the second configuration than when the image capture device is in the first configuration.

5. The image capture device of claim 1, wherein the first interconnect mechanism includes folding protrusions that are configured to rotate toward each other to move from the collapsed position to the extended position.

6. The image capture device of claim 5, wherein the second interconnect mechanism includes folding protrusions that are configured to rotate toward each other to move from the collapsed position to the extended position.

7. A camera housing, comprising:
a first surface;
a second surface noncoplanar with the first surface;
a first interconnect mechanism coupled to the first surface and rotatable between a collapsed position where protrusions of the first interconnect mechanism extend parallel to the first surface and an extended position where the protrusions of the first interconnect mechanism extend in a perpendicular manner away from the first surface; and
a second interconnect mechanism coupled to the second surface.

8. The camera housing of claim 7, wherein the second interconnect mechanism comprises protrusions configured to connect to a mounting component that is coupled to a mounting surface.

9. The camera housing of claim 8, wherein the protrusions of the second interconnect mechanism are rotatable between a collapsed position and an extended position.

10. The camera housing of claim 9, wherein the protrusions of the second interconnect mechanism include coplanar surfaces and extend adjacent to the second surface in the collapsed position and extend in a perpendicular manner away from the second surface in the extended position.

11. The camera housing of claim 7, wherein the first surface defines a recess and the protrusions of the first interconnect mechanism are at least partially disposed within the recess in the collapsed position.

12. The camera housing of claim 7, wherein the first interconnect mechanism is configured to mount an accessory to the camera housing.

13. The camera housing of claim 7, wherein in a first configuration of the camera housing, the first interconnect mechanism is configured to connect to a mounting component and the second interconnect mechanism is configured to connect to an accessory, and in a second configuration of the camera housing, the second interconnect mechanism is configured to connect to the mounting component and the first interconnect mechanism is configured to connect to an accessory.

14. An image capture device, comprising:
a body;
an image sensor;
a lens coupled to the body that directs light along an optical axis and onto the image sensor;
a first interconnect mechanism coupled to the body, the first interconnect mechanism comprising:
a first protrusion rotatable between a collapsed position and an extended position about a first axis of rotation that is parallel to the optical axis; and
a second protrusion rotatable between a collapsed position and an extended position about a second axis of rotation that is parallel to the optical axis; and
a second interconnect mechanism coupled to the body, the second interconnect mechanism comprising:
a third protrusion rotatable between a collapsed position and an extended position about a third axis of rotation that is perpendicular to the optical axis; and
a fourth protrusion rotatable between a collapsed position and an extended position about a fourth axis of rotation that is parallel to the optical axis.

15. The image capture device of claim 14, wherein:
the body comprises a first surface and a second surface perpendicular to the first surface;
the first interconnect mechanism is coupled to the first surface; and
the second interconnect mechanism is coupled to the second surface.

16. The image capture device of claim 15, wherein the second surface includes fins configured to dissipate heat.

17. The image capture device of claim 14, wherein in a first configuration of the image capture device, the first interconnect mechanism is configured to connect to a mounting component, wherein in a second configuration of the image capture device, the second interconnect mechanism is configured to connect to the mounting component, and wherein a torque imparted to the mounting component by the image capture device is less when the image capture device is in the second configuration than when the image capture device is in the first configuration.

18. The image capture device of claim 14, wherein the first protrusion and the second protrusion extend along an outer surface of the body in the collapsed position and extend in a perpendicular manner away from the body in the extended position.

19. The image capture device of claim 18, wherein the third protrusion and the fourth protrusion are approximately flush with an outer surface of the body in the collapsed position and extend away from the body in the extended position.

20. The image capture device of claim 14, wherein to rotate between the collapsed position and the extended position, the first protrusion is rotatable about the first axis in a direction opposite a direction the second protrusion is rotatable about the second axis, and wherein to rotate between the collapsed position and the extended position, the third protrusion is rotatable about the third axis in a direction opposite a direction the fourth protrusion is rotatable about the fourth axis.
